(19) United States
(12) Patent Application Publication
(10) Pub. No.: US 2006/0130773 A1
(43) Pub. Date: Jun. 22, 2006

(54) Wall mounted flat screen aquarium w/interchangeable frames and mountings for pictures/art work

(76) Inventors: Narda Dene Margerum Shawver, Peru, IN (US); Linda Rae McCoy Shawver, Peru, IN (US)

Correspondence Address: NARDA D MARGERUM, 2934 W 500 S, PERU, IN, 46970, US

(21) Appl. No.: 11/269,171

(22) Filed: Nov. 8, 2005

Related U.S. Application Data
(60) Provisional application No. 60/626,158, filed on Nov. 8, 2004.

(51) Int. Cl. A01K 63/00

(52) U.S. Cl. 119/257

(57) ABSTRACT

Combination Aquarium/Terrarium/Critter Cage with interchangeable picture frames which includes molded slide in picture area on the back of the aquarium, attachable side panels, and unique mounting for hanging on a stationary wall. Interchangeable picture and frame novelty aquarium in various sizes and shapes mounted to a stationary wall with reversed mitered wall bracket that is easy to mount. Unlike other aquariums this invention is manufactured by using injection molding for lower costs to the consumer. The included filter and light will be hidden by the interchangeable frame so that all one sees is the frame, picture and fish when viewing. Side panels are attached to each side keeping the light inside. Proper ventilation is assured by the top being open for a supply of natural oxygen for healthy fish. The lightweight and safety of the aquarium will be adequately supported by the reverse miter wall bracket.

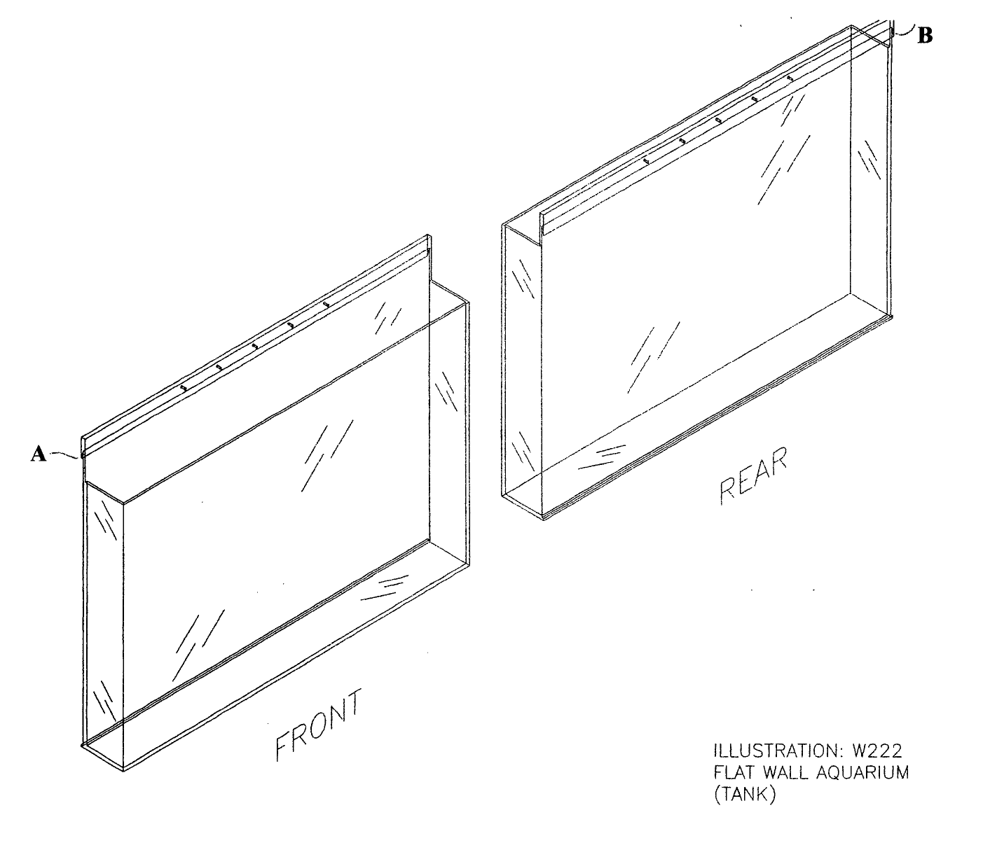

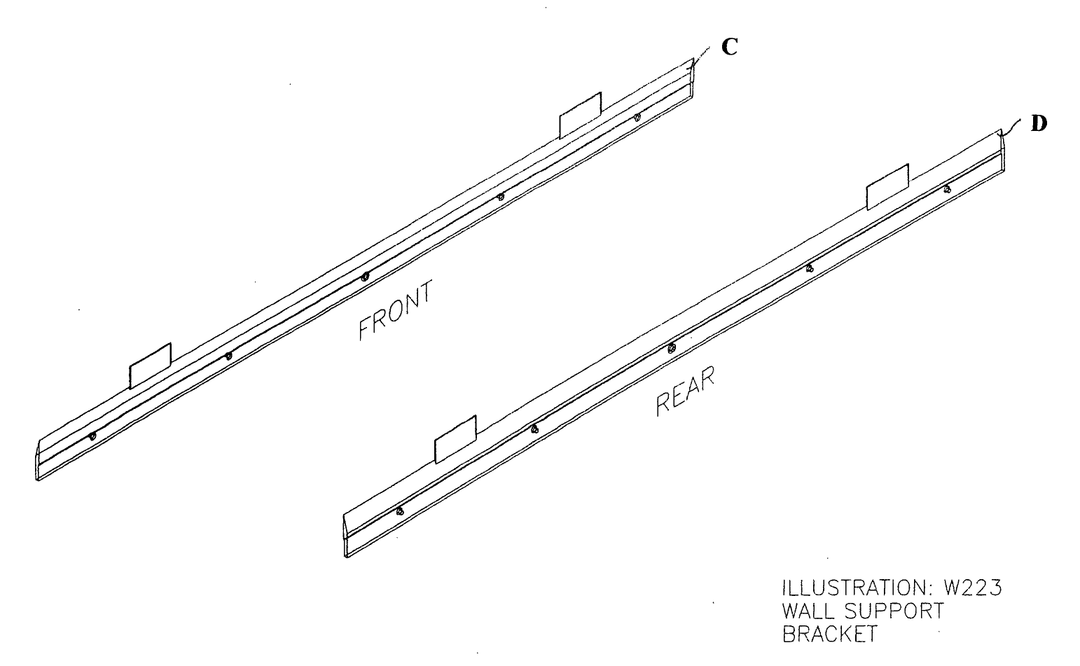

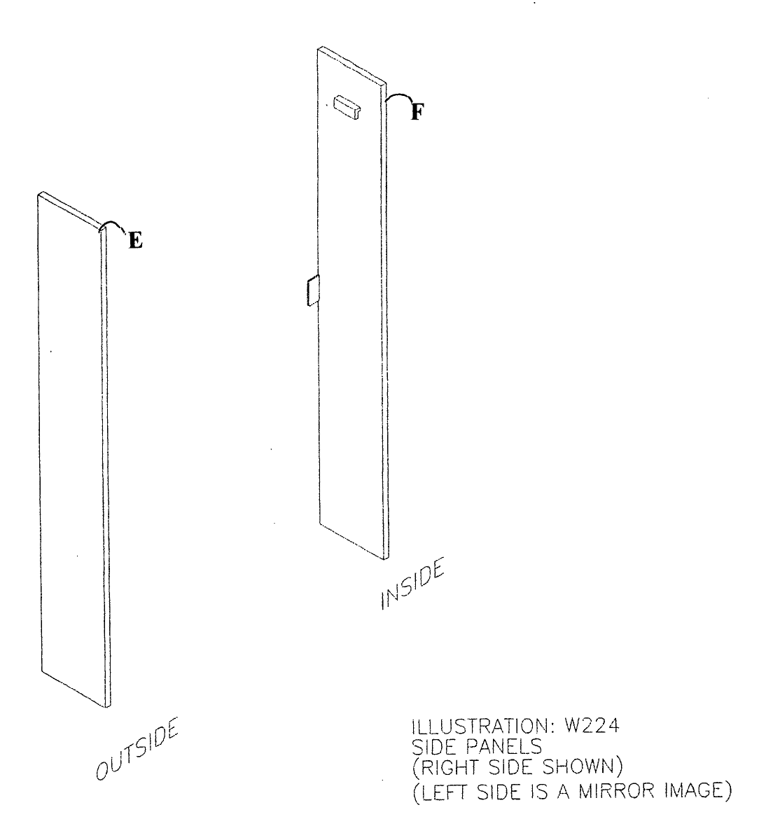

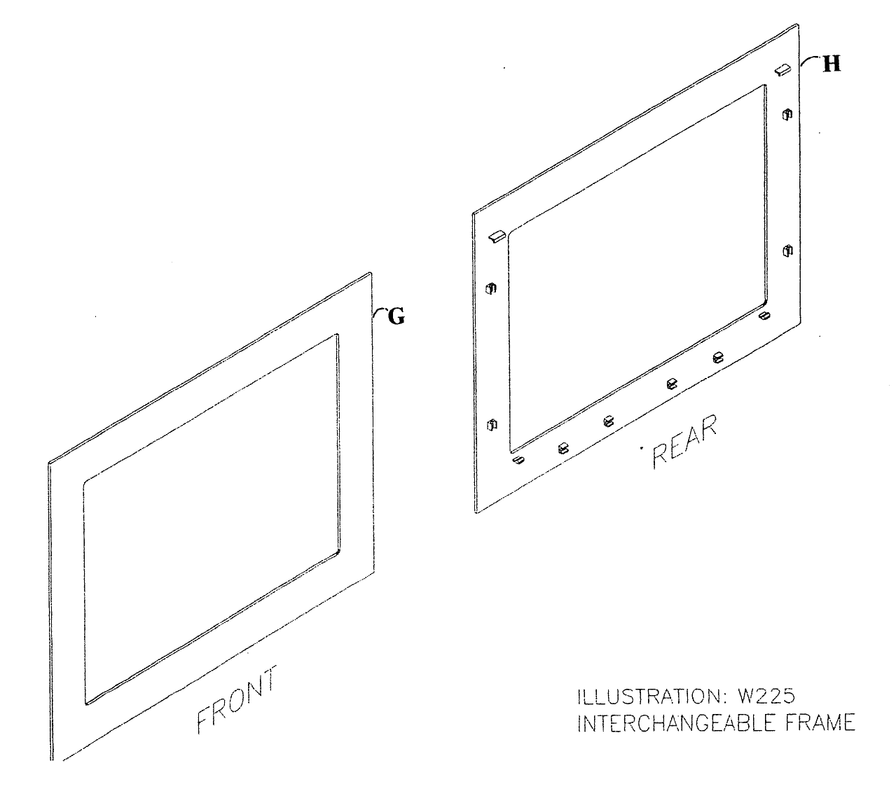

### CROSS-REFERENCE TO RELATED APPLICATIONS

This application claims the benefit of provisional patent application Ser. No. 60/518,704 filed 2003 Nov. 10: No. 60/626,158 filed 2004 Nov. 08 both by the present inventors listed above.

### FEDERALLY SPONSORED RESEARCH

Not Applicable

### SEQUENCE LISTING

Not Applicable

### DESCRIPTION OF INVENTION

1. Field of Invention

This invention relates to an aquarium, more particularly, this invention relates to an aquarium that is mounted on a wall.

2. Description of Prior Art

Many different types of aquariums exist. None of the prior art discloses the features of the present invention.

3. Primary Objectives

This invention is made to provide a living piece of art mounted to a wall that is easy, inexpensive and one has the ability to adapt it to all kinds of decorating needs with fish, color frames/side panels, plants, aquatic life and small reptiles.

### DESCRIPTION OF INVENTION

Frame A Fish (registered trademark) Combination Aquarium/Terrarium/Critter Cage with interchangeable front picture frames which includes a slide in picture area on the back of the aquarium, attachable side panels, and unique mounting for hanging on a stationary wall.

An interchangeable picture and frame novelty aquarium/terrarium that is mounted to a stationary wall with reversed mitered wall bracket that is easy to mount and dismount for occasional cleaning. Unlike other aquariums this invention is able to be manufactured by using injection molding and can be manufactured in many different sizes and shapes.

The included filter and light, which is attached to the top, will be hidden by the removable frame so that all one sees is the frame, picture and fish when viewing on the wall. Side panels are attached to each side of the aquarium to keep the light inside the tank. Proper ventilation is assured due to the top being open for a supply of natural oxygen for the health of the fish.

The weight and safety of the aquarium will be adequately supported by the reverse miter wall bracket. It is lightweight and easy to maintain.

### ILLUSTRATION FIGURES

Page 6 W222

Figure A: Front of tank molded of clear acrylic or other material and can be of any clear material ranging in size and shape. Consists of front, 2 sides and bottom.

Figure B: Back of tank including the reversed miter edge to attach to wall bracket making the tank fit tight and safely to the wall. Narrow shelf at bottom of tank to to hold picture/art work.

Page 7 W223

Figure C: Front of support wall bracket which will be the length of the aquarium and will have a reverse miter edge with safety clips molded onto strip to prevent aquarium from sliding side to side.

Figure D: Same as above with notched out strip for picture/art to slide into.

Page 8 W224

Figure E: Side panel that faces toward the outside and is a mirror image of figure F.

Figure F: Side that faces inside of tank that is showing the clip and picture holder.

Page 9 W225

Figure G: Front of frame that comes in various shapes and colors.

Figure H: Back of frame that shows cord holders and clips for attaching frame to tank.

1. An injection molded aquarium that attaches to a wall using reverse miter strips with specially designed safety tabs to prevent sliding from side to side, tank side being molded onto the back and wall mount being a separate piece.

2. Injection molding process makes the unit inexpensive, less adhesive needed and therefore making it an affordable and safe unit for distribution.

3. Interchangeable color frame, that is designed to be offset to hide filter, side panels to contain light inside and slider tabs on bottom back ledge for artwork/pictures to be easily placed behind aquarium while hanging on the wall, for viewing only the water, fish and frame.
